(19) United States
(12) Patent Application Publication
(10) Pub. No.: US 2003/0172188 A1
(43) Pub. Date: Sep. 11, 2003

(54) Virtual local area network connecting equipment

(76) Inventors: Takashi Hasegawa, Tokyo (JP); Koichiro Seto, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/373,591

(22) Filed: Feb. 26, 2003

(30) Foreign Application Priority Data
Feb. 27, 2002 (JP) 2002-51656
Feb. 27, 2002 (JP) 2002-51658
Jan. 14, 2003 (JP) 2003-6044

(51) Int. Cl. G06F 15/16; H04L 12/28; H04L 12/56

(52) U.S. Cl. 709/249; 370/401

(57) ABSTRACT

A virtual local area network (VLAN) connecting equipment which makes possible to relay frame of VLAN without taking off tag from frame, and to increase user accommodating capacity while persisting established network is provided. Virtual local area network connecting equipment, comprising, regional side port connected to a regional network, wide area side port connected to a wide area network, means for relaying frame from regional side port to wide area side port and from wide area side port to regional side port after converting virtual local area network identification number with reference to table provided with previously registered correspondence between virtual local area network identification number in regional network and virtual local area network identification number in wide area network.

### BACKGROUND OF THE INVENTION

1. Field of the Invention

The present invention relates to virtual local area network (VLAN) connecting equipment which builds up wide area VLAN, and more specifically to a VLAN connecting equipment which makes possible to relay VLAN frame without taking off VLAN tag from frame, and to increase user accommodating capacity while persisting established network.

2. Prior Art

In VLAN defined by IEEE802. 1Q, by adding identification number VLAN ID (VID) for identifying VLAN group and information TPID for classifying protocol type of VLAN to a header portion of the frame, the frame is relayed properly, and is transmitted and received by only a terminal belonging to the VLAN group. Both VID and TPID are collectively called VLAN tag. By using different VID, plural VLAN can be formed independently each other on one common LAN. Because VID field within a frame is 12 bit length, about four thousand kinds of different VID can be made. Namely, it is possible to operate about four thousand VLAN on one common LAN. When VLAN is built up in each independent LAN, even if same VID is used in both LAN (these are expressed as different policy VLAN domain), interruption does not occur each other.

In FIG. 1, a part of VLAN frame structure is shown. The VLAN frame is provided with destination address field 91, source address field 92, and type field 93 that are same in normal frame, and further provided with TPID field 93 and VID field 95 adding to the normal frame.

On the other hand, it is possible to connect plural LAN each other, by forming a large scale network provided with long distance transmission line and connecting plural LAN respectively with this large scale network. Hereinafter, a network spread over one city area is called a regional network, and a network spread over nationally is called a wide area network. By intervening a wide area network, plural regional network which have not been interconnected until now can be interconnected. According to this, communication from each regional network to other regional network becomes possible.

However, in case of connecting VLAN configured regional network with wide area network, problem that VID overlaps with other regional network (different policy VLAN domain) occurs. Namely, there may be a case that VLAN which is built up on a single regional network is using the same VID as VLAN which is built up on other single regional network, if interconnection between regional networks is performed through a wide area network, distinguishing ability will be lost.

Further, there is VLAN (for the distinction, referred to as “expanded VLAN”) defined by different standard from IEEES802. 1Q. In expanded VLAN, expanded VLAN tag is further added to frame provided with VLAN tag. Expanded VLAN is originally defined by manufacturer who offers connecting equipment, TPID in expanded VLAN shows a kind of expanded VLAN (manufacturer proprietary function). It is impossible to interconnect between networks provided with different kind of expanded VLAN each other.

In FIG. 2, a part of frame structure of expanded VLAN is shown. Comparing with FIG. 1, it is apparent that TPID field 101 and VID field 102 for expanded VLAN are added.

In order to solve these problems, in prior art, as shown in FIG. 3, a tag take on/take off equipments which take on and take off tag are installed at gateway of a regional network and a wide area network, when the frame 111 goes out from the regional network, VLAN tag and expanded VLAN tag for the regional network are taken off, when the frame 112 enters into the wide area network, the frame 113 is formed by taking on tag and identifying number for the wide area network again. When the frame goes out from the wide area network, tag and identifying number for the wide area network are taken off, and when enters into the regional network, VLAN tag and expanded VLAN tag for regional network are taken on.

However, in the prior art system, it is necessary to install tag take on/take off equipments at both regional network side and wide area network side respectively, in the place where each regional network is connected to wide area network.

Further, in the connection between the tag take on/take off equipments, one VID is allocated to one port of regional network side tag take on/take off equipments, and identified number for one wide area network is allocated to one port of wide area network side tag take on/take off equipments. When connecting between both tag take on/take off equipments, mistake of port configuration causes mismatching of VID and identifying number in the wide area network. But, it is not easy to control to connect plural transmission path between tag take on/take off equipments to right partner.

Further more, in the prior art system, responsibility dividing point between the regional network and the wide area network is not clear. Namely, proper connecting of regional network to regional network side tag take on/take off equipment is carried out under responsibility of the regional network side. On the other hand, proper connecting of wide area network to wide area network side tag take on/take off equipment is carried out under responsibility of the wide area network side. However, it is impossible to determine responsibility of connecting between tag take on/take off equipments. Though the responsibility dividing point shown in FIG. 3 is drawn at intermediate of transmission path, this means that responsibility dividing point is not clear.

Further more, in IEEE802. 1Q standard, because a VID field is only 12 (twelve) bit length, accommodative user is limited up to about four thousand. If this system is applied to nationwide wide area network, it is impossible to accommodate all user desiring VLAN service. However, if new standard provided with widened VID field for increasing capacity is introduced, already operating regional network would be discarded.

### SUMMARY OF THE INVENTION

An object of the present invention is to provide VLAN connecting equipment which makes possible to relay frame of VLAN without taking off tag from frame, and to increase user accommodating capacity while persisting established network.

In accordance with this invention, there is provided a virtual local area network connecting equipment, comprising, regional side port connected to a regional network, wide area side port connected to a wide area network, and means for relaying frame from regional side port to wide area side port and from wide area side port to regional side port after converting virtual local area network identification number with reference to table provided with previously registered correspondence between virtual local area network identification number in regional network and virtual local area network identification number in wide area network.

In accordance with this invention, there is provided a virtual local area network connecting equipment, wherein, said table is stored with correspondence including regional side port number and wide area side port number, and frame destination port is determined in accordance with said table.

In accordance with this invention, there is provided a virtual local area network connecting equipment, wherein, said virtual local area network identification number in wide area network is provided with larger digit number than said virtual local area network identification number in regional network.

In accordance with this invention, there is provided a virtual local area network connecting equipment, wherein, further includes means for recalculating and rewriting check cord at the end of frame when said virtual local area network identification number is converted.

In accordance with this invention, there is provided a virtual local area network connecting equipment, comprising, regional side port connected to a regional network, wide area side port connected to a wide area network, means for converting virtual local area network identification number in regional network stored in frame received at regional side port to virtual local area network identification number in wide area network and transmitting said frame from wide area side port, means for converting virtual local area network identification number in wide area network stored in frame received at wide area side port to virtual local area network identification number in regional network and transmitting said frame from regional side port, and media access controller (MAC) which transfers frame between said port and said converter.

In accordance with this invention, there is provided a virtual local area network connecting equipment, wherein, said media access controller stores port number to frame entered from regional side port, transfer frame to converter, and transfer frame to wide area side port in accordance with port number written in the returned frame from converter, and said converter decides virtual local area network identification number in wide area network and transmitting port number in accordance with receiving port number and virtual local area network identification number in regional network stored in the transferred frame from media access controller, returns to media access controller after rewriting frame from receiving port number and virtual local area network identification number in regional network to decided virtual local area network identification number in wide area network and transmitting port number, decides virtual local area network identification number in regional network and transmitting port number in accordance with receiving port number and virtual local area network identification number in wide area network stored in the transferred frame from media access controller, and returns to media access controller after rewriting frame from receiving port number and virtual local area network identification number in wide area network to decided virtual local area network identification number in regional network and transmitting port.

In accordance with this invention, there is provided a virtual local area network connecting equipment, comprising, regional side port connected to a regional network, wide area side port connected to a wide area network, means for converting virtual local area network identification number in regional network stored in a frame received at regional side port to virtual local area network identification number in wide area network and transmitting said frame from wide area side port, means for converting virtual local area network identification number in wide area network stored in a frame received at wide area side port to virtual local area network identification number in regional network and transmitting said frame from regional side port, and media access controller provided between each port of regional side and wide area side and converter which mutually converts virtual local area network identification number in regional network and virtual local area network identification number in wide area network.

In accordance with this invention, there is provided a virtual local area network connecting equipment, comprising, regional side port connected to a regional network, wide area side port connected to a wide area network, converter which mutually converts virtual local area network identification number in regional network and a virtual local area network identification number in wide area network, and media access controller which transfers frame between said port and said converter.

In accordance with this invention, there is provided a virtual local area network connecting equipment, comprising, plural regional side port connected to a regional network, plural wide area side port connected to a wide area network, converter which mutually converts virtual local area network identification number in regional network and a virtual local area network identification number in wide area network, media access controller which transfers frame between said plural regional side port and said converter, and media access controller which transfers frame between said plural wide area side port and said converter.

In accordance with this invention, there is provided a virtual local area network connecting equipment, comprising, plural regional side port connected to a regional network, plural wide area side port connected to a wide area network, converter which mutually converts virtual local area network identification number in regional network and a virtual local area network identification number in wide area network, media access controllers each of which is disposed between said each regional side port and said converter and transfers frame between said each regional side port and said converter, and media access controllers each of which is disposed between said each wide area side port and said converter and transfers frame between said each wide area side port and said converter.

### BRIEF DESCRIPTIONS OF THE DRAWINGS

The invention will be explained in more detail in conjunction with the appended drawings, wherein:

FIG. 1 is an explanatory view showing a structure of VLAN frame.

FIG. 2 is an explanatory view showing a structure of expanded VLAN frame.

FIG. 3 is an explanatory view showing a conventional network.

FIG. 4 is an explanatory view showing first embodiment of the present invention.

FIG. 5 is an explanatory view showing second embodiment of the present invention.

FIG. 6 is an explanatory view showing inner structure of VLAN connecting equipment in accordance with an embodiment of the present invention.

FIG. 7 is an explanatory view showing ID converting table used in an embodiment of the present invention.

FIG. 8 is an explanatory view showing rewriting of frame used in an embodiment of the present invention.

FIG. 9(a) and FIG. 9(b) are explanatory views showing ID converting tables used in another embodiment of the present invention.

FIG. 10 is an explanatory view showing inner structure of VLAN connecting equipment in accordance with third embodiment of the present invention.

FIG. 11 is an explanatory view showing inner structure of VLAN connecting equipment in accordance with fourth embodiment of the present invention.

### DESCRIPTION OF THE PREFERRED EMBODIMENTS

Preferred embodiments of the present invention will be explained in conjunction with accompanying drawings.

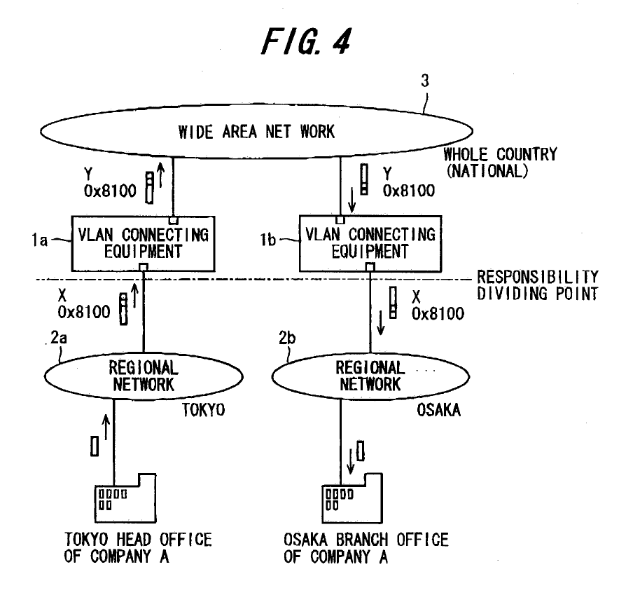

VLAN connecting equipment in accordance with first embodiment of the present invention is shown in FIG. 4. VLAN connecting equipment 1a, 1b is connecting between regional network 2a, 2b and wide area network 3 respectively. The VLAN connecting equipment 1a, 1b operates to convert VID in regional network 2a, 2b stored in the frame received at the regional side port to VID in wide area network 3, transmit the frame from the wide area side port, convert VID in wide area network 3 stored in the frame received at the wide area side port to VID in regional network 2a, 2b, and transmit the frame from the regional side port.

In FIG. 4, one regional network 2a is in Tokyo, another regional network 2b is in Osaka, Tokyo head office of company A is connected to Tokyo network 2a, Osaka branch office of Company A is connected to Osaka network 2b, and Tokyo network 2a and Osaka network 2b are connected to national network 3 through VLAN connecting equipment 1a, 1b respectively.

Company A is using expanded VLAN in each regional network 2a, 2b, VID of Company A in Tokyo network 2a is X, and VID of Company A in Osaka network 2b is Z. Accordingly, the frame transmitted from Tokyo head office becomes expanded VLAN frame in FIG. 2 in Tokyo network 2a, X is stored in VID field 102 of expanded VLAN tag. Further, in order to relay the frame to Osaka branch office in Osaka network 2b, Z must be stored in VID field 102 of expanded VLAN frame. And VID of Company A in national network is Y.

Further, Ethernet type in expanded VLAN group to which Tokyo head office belongs is 0x9100, and Ethernet type in expanded VLAN group to which Osaka branch office belongs is 0x8100. These Ethernet types are stored in TPID field 101 of expanded VLAN tag. In addition, Ethernet is registered trademark.

In this system, when Tokyo head office transmits the frame, then expanded VLAN tag is added in Tokyo network 2a. X is stored in VID field 102 of expanded VLAN tag, and 0x9100 is stored in TPID field 101. When Tokyo network 2a side VLAN connecting equipment 1a receives this expanded VLAN frame, X stored in VID field 102 is converted to Y, 0x9100 stored in TPID field 101 is converted to 0x8100, and the expanded VLAN frame is transmitted to national network 3. This expanded VLAN frame arrives at Osaka network 2b side VLAN connecting equipment 1b. With respect to expanded VLAN frame received from national network 3, Osaka network 2b side VLAN connecting equipment 1b, converts Y stored in VID field to Z, convert value stored in TPID field 101, and transmit the expanded VLAN frame to Osaka network 2b. This expanded VLAN frame can be received by Osaka branch office in Osaka network 2b. Accordingly, the frame transmitted from Tokyo head office can be received by Osaka branch office. Even though there is expanded VLAN user whose VID is X in Osaka network 2b, this VID is independent of VID in Tokyo network 2a, prior art duplication problem does not occur.

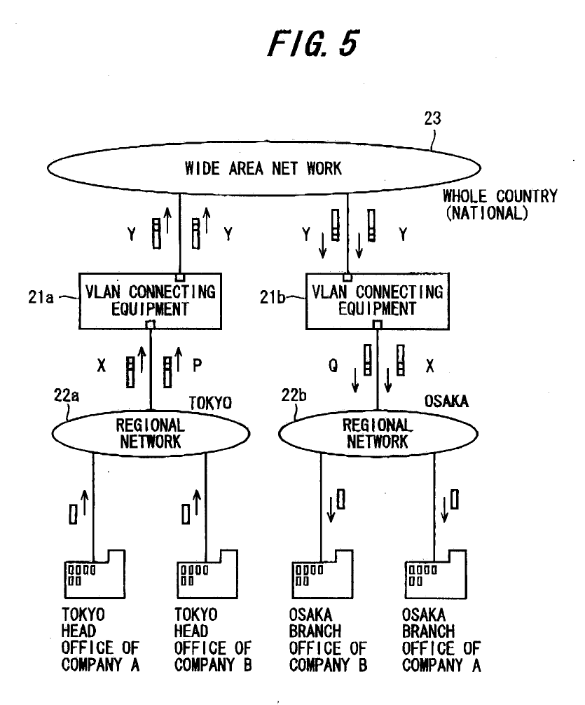

Second embodiment of the present invention will be explained. VLAN connecting equipment 21a, 21b shown in FIG. 5 has VID multiplexing function. Similar to FIG. 4, one regional network 22a is in Tokyo, another regional network 22b is in Osaka, Tokyo network 22a and Osaka network 22b are connected to national network 3 through VLAN connecting equipment 21a, 21b respectively. Further, in addition to Tokyo head office of Company A, Tokyo head office of Company B is also connected to Tokyo network 22a, and in addition to Osaka branch office of Company A, Osaka branch office of Company B is also connected to Osaka network 22a. In each regional network 22a, 22b, Company A and Company B belong to independent VLAN group, VID of Company A in Tokyo network 22a is X, VID of Company B in Tokyo network is P, VID of Company A in Osaka network 22b is Z, and VID of Company B in Osaka network 22b is Q.

VID of Company A and VID of Company B in national network 23 are Y respectively. In the present invention, VID in national network 23 is defined as GVID which is larger digit number than VID in regional network 22a, 22b. Concretely, GVID is 16 bit length while conventional VID is 12 bit length. Because VID field provided in IEEE802. 1Q is only 12 bit, a part of GVID is stored in 4 bit in user-priority and CFI (hereinafter described as “pri/CFI”) field provided in IEEE802. 1Q. Accordingly, considering only VID field, VID of Company A and VID of Company B appear to be same, but Company A and Company B can be identified by pri/CFI field. As described above, it is called VID multiplexing function to increase capacity of VLAN by providing digit number of GVID in wide area network 23 larger than VID in regional network 22a, 22b. When 4 bit of pri/CFI field is allocated to GVID, 16 times of conventional, namely about sixty-five thousand GVID can be used. Further, in order to increase GVID digit number, it is possible to use voluntary bit of TPID depending on global side equipment.

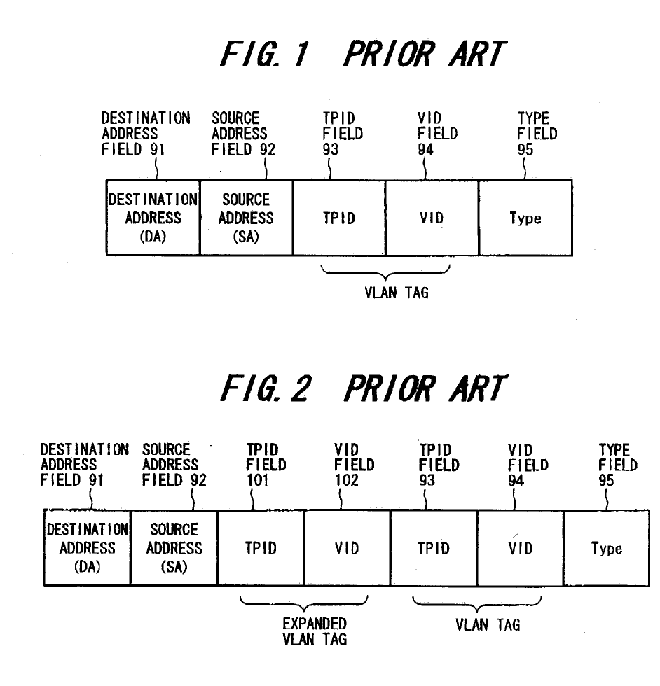

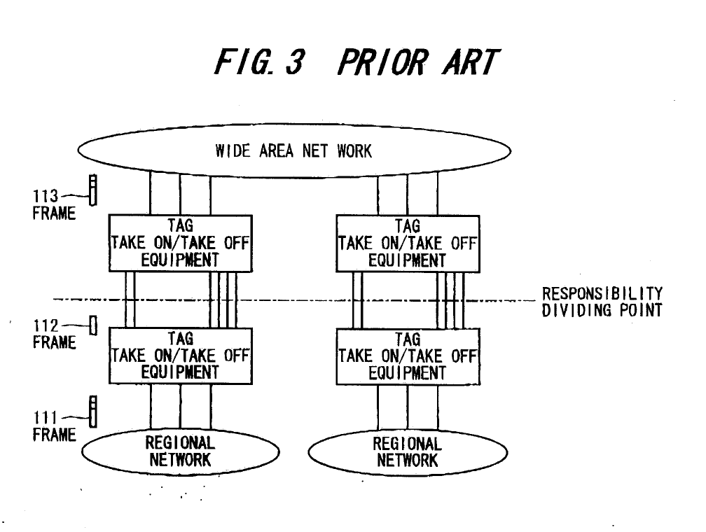

In this system, when Tokyo head office of Company A transmits the frame, VID field 94 value of VLAN frame (FIG. 1) transmitting Tokyo network 22a becomes X. Tokyo network 22a side VLAN connecting equipment 21a converts this VID field 94 value of VLAN frame to Y, and determines 4 bit (not shown in the figure) based on GVID of Company A. Namely, GVID of Company A is expressed as 16 bit by adding 4 bit to Y (12 bit). Osaka network 22b side VLAN connecting equipment 21b which received this VLAN frame from national network 23 converts GVID of Company A to Z which is VID in Osaka network 22b and transmits to Osaka network 22b. Accordingly, Osaka branch office of Company A can receive the frame from Tokyo head office of Company A.

Further, when Tokyo head office of Company B transmits the frame, VID of VLAN frame becomes P. Tokyo network 22a side VLAN connecting equipment 21a converts this VID of VLAN frame to Y, and determines 4 bit (not shown in the figure) based on GVID of Company B. The numerical value expressed by this 4 bit is of course different from it of Company A. Osaka network 22b side VLAN connecting equipment 21b which received this VLAN frame from national network 23 converts GVID of Company B to Q which is VID in Osaka network 22b and transmits to Osaka network 22b. Accordingly, Osaka branch office of Company B can receive the frame from Tokyo head office of Company B.

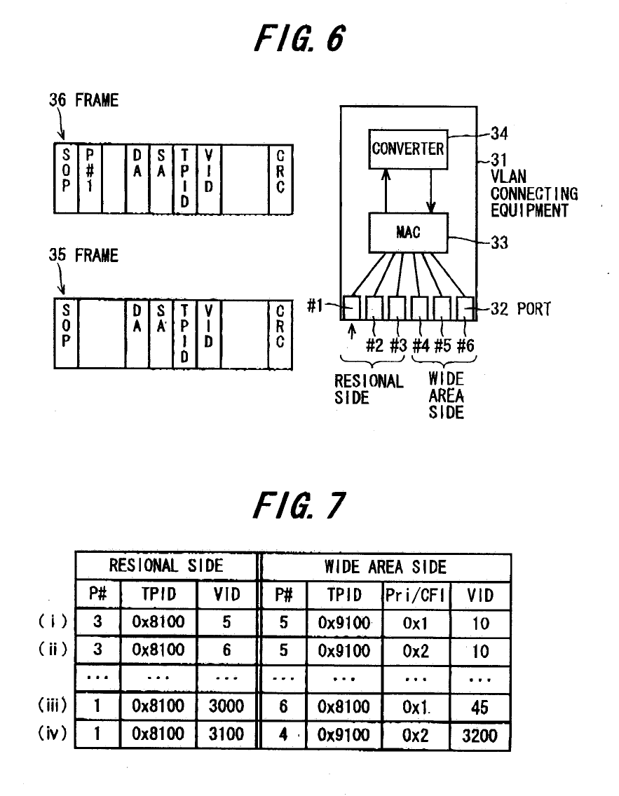

VID converting procedure in VLAN connecting equipment will be explained. As shown in FIG. 6, VLAN connecting equipment 31 in accordance with an embodiment of the present invention, comprising, plural port 32 allocated to regional network and wide area network, converter 34 which mutually converts VID and GVID, and MAC 33 which transfers frame between plural port 32 and converter 34. Ports #1-#3 are connected to regional network, and ports #4-#6 are connected to wide area network.

MAC 33 is provided with function of adding number of port 32 to frame which comes from the port 32 and transferring it to the converter 34, and function of forwarding the frame to the port 32 in accordance with port number (transmitting port number) written in the returned frame from the converter 34. For example, as shown in FIG. 6, the frame 35 which comes from the port #1 to the MAC 33 is added port number “P#1” next to SOP field like the frame 36 and transferred to the converter 34. On this occasion, check cord (CRC) value may be changed by calculation, but other field must not be changed. In addition, SOP is a code showing head of packet, DA is a destination address, and SA is a source address.

The converter 34 is provided with functions of deciding GVID and transmitting port number based on receiving port number and VID stored in the transferred frame from MAC 33, returning to MAC 33 after rewriting frame from receiving port number and VID to decided GVID and transmitting port, deciding VID and transmitting port number based on receiving port number and GVID stored in the transferred frame from MAC 33, and returning to MAC 33 after rewriting frame from receiving port number and GVID to decided VID and transmitting port.

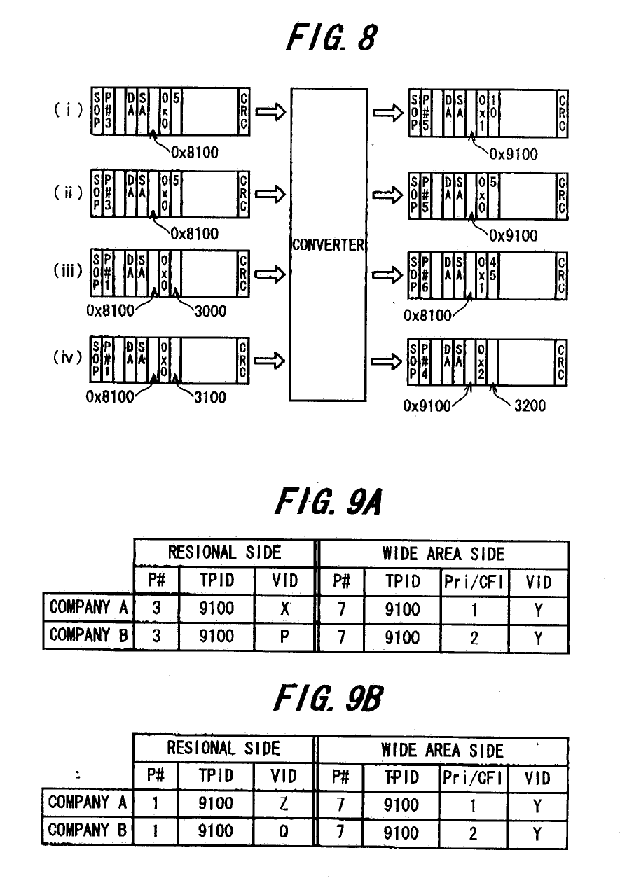

Means for realizing these converting functions, the converter 34 is provided with ID converting table which coordinately stored regional network side information and wide area network side information. ID converting table shown in FIG. 7 divides regional network side and wide area network side into right and left respectively. The regional network side information comprises category for port number (P#), TPID, and VID. The wide area network side information comprises category for port number (P#), TPID, pri/CFI and VID. In ID converting table shown in FIG. 7, embodiments (i), (ii), (iii) and (iv) are written. Regarding these embodiments, renewed contents of the frame will be explained with reference to FIG. 8.

As shown in the case (i) in FIG. 8, the port number “P#3” and VID “5” stored frame is entered to converter 34. In this frame, pri/CFI is considered to be “0x0”, since this frame is provided from the regional network side, this data is not used. The converter 34 refers to ID converting table in FIG. 7 with respect to port number and VID, and obtains wide area network side information. And port number “P#5”, VID “10” and pri/CFI “0x1” are written to the frame. As explained above, 16 bit obtained by combining VID and pri/CFI is GVID. At the same time, the converter 34 transfers TPID from “0x8100” to “0x9100”. And the converter 34 changes CRC value by calculation.

As shown in the case (ii), the port number “P#5”, VID “10” and pri/CFI “0x2” stored frame is entered to converter 34. This frame is come from the wide area network. The converter 34 refers to ID converting table with respect to port number and VID, and obtains regional network side information. And the port number “P#3” and VID “6” are written to the frame. Transferring of pri/CFI is not necessary, because it is not used, but “0x0” is written in this case. At the same time, the converter 34 transfers TPID from “0x9100” to “0x8100”. And the converter 34 changes CRC value by calculation.

The case (i) was explained when the regional network side frame was entered, and the case (ii) was explained when the wide area network aide was entered, but each case is realized even though the arrow in FIG. 8 is reversed. For example, in reverse case of (i), when the port number “P#5”, VID “10” and pri/CFI “0x1” stored frame is entered to the converter 34, the port number “P#3”, VID “5” stored frame is output. Comparing the case (ii) and the reverse case of (i), it is understood that VID “10” is appeared in both cases but the identification is fulfilled by pri/CFI.

In the case (iii), the port number “P#1”. VID “3000” and the port number “P#6”, VID “45”, pri/CFI “0x1” are converted each other. In the case (iv). the port number “P#1”, VID “3100” and the port number “P#4”, VID “3200”, pri/CFI “0x2” are converted each other, and TPID “0x8100” and TPID “0x9100” are converted each other.

When the converting process of above VID is applied to an embodiment in FIG. 5, the operation will be explained as follows. ID converting table of Tokyo network 22a side VLAN connecting equipment 21a is established as shown in FIG. 9(a). ID converting table of Osaka network 22b side VLAN connecting equipment 21a is established as shown in FIG. 9(b). The frame transmitted by Tokyo head office of Company A becomes VLAN frame by converting VID to be X, enters port #3 of VLAN connecting equipment 21a, and transmitted to national network 23 from port #7 by converting VID to be Y and pri/CFI to be 1. This VLAN frame enters port #7 of VLAN connecting equipment 21b, and transmitted to Osaka network 22b from port #1 by converting VID to be Z. Accordingly Osaka branch office of Company A can receive this frame. Further, the frame transmitted by Tokyo head office of Company B becomes VLAN frame by converting VID to be P, enters port #3 of VLAN connecting equipment 21a, and transmitted to national network 23 from port #7 by converting VID to be Y and pri/CFI to be 2. This VLAN frame enters port #7 of VLAN connecting equipment 21b, and transmitted to Osaka network 22b from port #1 by converting VID to be Q. Accordingly Osaka branch office of Company B can receive this frame.

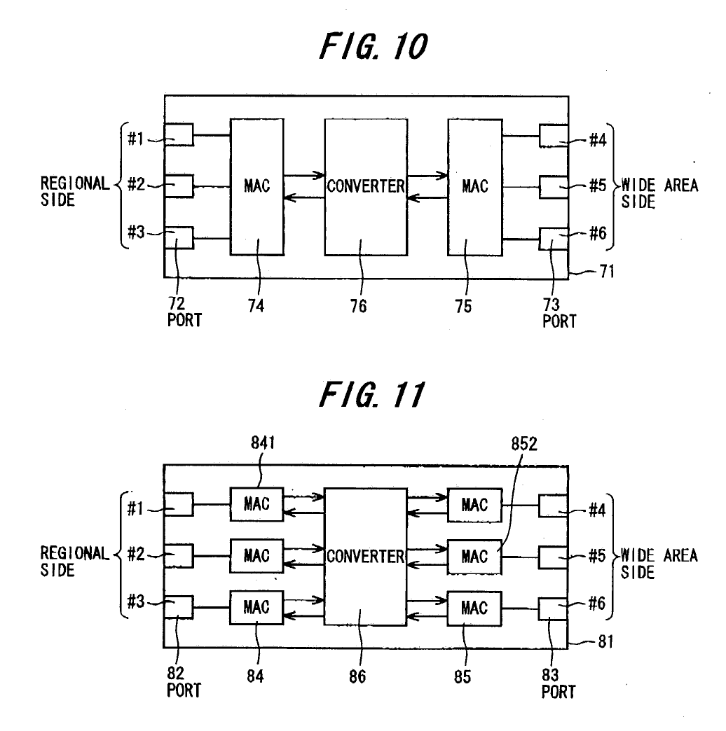

Third embodiment of the present invention will be explained. VLAN connecting equipment 71 shown in FIG. 10 comprising, plural regional side port 72 connected to regional network, plural wide area side port 73 connected to wide area network, converter 76 which mutually converts VID and GVID, MAC 74 which transfers frame between plural of regional side port 72 and converter 76, and MAC 75 which transfers frame between plural of wide area side port 73 and converter 76. MAC 74 is provided with function of adding the port number to the frame which entered from the regional side port 72 and transferring it to the converter 76, and function of forwarding the frame to the regional network side port in accordance with the port number written in the returned frame from the converter 76. MAC 75 is provided with function of adding the port number to the frame which entered from the wide area side port 73 and transferring it to the converter 76, and function of forwarding the frame to the wide area network side port in accordance with the port number written in the returned frame from the converter 76.

Fourth embodiment of VLAN connecting equipment of the present invention is shown in FIG. 11. This VLAN connecting equipment 81 is provided with MAC 84 and MAC 85 respectively, between each regional side port 82 connected to regional network and converter 86, and between each wide area side port 83 connected to wide area network and converter 86. Because each port is provided with individual MAC respectively, it becomes possible for the converter 86 to identify port number irrespective of hardware constitution without reading the port number in the frame. Consequently, it becomes unnecessary for MAC 84 and MAC 85 to write the port number to the frame entered from regional side port 82 or wide area side port 83. Accordingly, MAC 84 is enough to be provided with function of transferring the frame entered from the regional side port 82 connected to the regional network to the converter 86, and function of forwarding the frame entered from the converter 86 to the corresponding regional network, and MAC 85 is enough to be provided with function of transferring the frame entered from the wide area side port 83 connected to the wide area network to the converter 86, and function of forwarding the frame entered from the converter 86 to the corresponding regional network. Further, it becomes unnecessary for the converter 86 to rewrite the port number, therefore, the converter 86 is enough to be provided with function which converts VID and GVID each other.

For example, when the frame entered to MAC 841 from regional side port #1, MAC 841 transfer the frame directly to the converter 86, the converter 86 provided with ID converting table which coordinately stored regional network side information and wide area network side information, determines GVID and transmitting port number based on VID stored in the frame transferred from MAC 841 and received port number discriminated from MAC 841 which is transferring source of the frame, rewrites VID in the frame to determined GVID, and transfers the frame to MAC corresponding to determined transmitting port number. For example, when determined transmitting port number is #5, the converter 86 transfers the frame to MAC 852, and MAC 852 forwards the frame transferred from the converter 86 to wide area side port #2.

As described above, by providing independent MAC between each port and converter respectively, it becomes unnecessary for MAC to write port number, and for converter to read port number in frame and to rewrite port number during converting. Accordingly, it becomes possible to decrease frame relay process.

As explained above in detail, because conventional VLAN was objected to only independent regional network, and skills necessary for interconnecting different policy VLAN domain each other was lacking, therefore tag take on/take off equipment was required in applying to wide area network. According to the present invention, since VLAN tag content could to be converted each other for regional purpose and wide area purpose without taking off VLAN tag, tag take on/off equipment became unnecessary. Accordingly, maintenance of tag take on/off equipment became unnecessary, and responsibility dividing point became clear.

In conventional VLAN, because VID digit number was limited, there was fear that it is difficult to accommodate all user desiring service in wide area network. In the present invention, since GVID provided with increased digit number is used, large number of user can be accommodated. If the increase of digit number is to be covered with pri/CFI which is conventionally prepared as priority information storing field, capacity increases 16 times. VID used in VLAN of already persisting regional network can be used successfully without modification.

Further, in the present invention, since ID converting table in which VID/GVID correspondence is registered is used for mutual converting of VID/GVID, maintenance becomes easy.

Further more, in the present invention, since port number is established to regional side and wide area side of table respectively, and adding of receiving port number and destination determination by transferring port number are carried out in MAC, frame transferring path between regional side and wide area side can be established in the table.

The present invention exhibits superior effects as follows.

(1) It becomes possible to relay frame of VLAN without taking off tag from frame.

(2) It becomes possible to increase user accommodating capacity while persisting established network.

Although the invention has been described with respect to specific embodiment and clear disclosure, the appended claims are not to be thus limited but are to be construed as embodying all modification and alternative constructions that may be occurred to one skilled in the art which fairly fall within the basic teaching herein set forth.

What is claimed is:

1. A virtual local area network connecting equipment, comprising:
regional side port connected to a regional network;
wide area side port connected to a wide area network;
means for relaying frame from regional side port to wide area side port and from wide area side port to regional side port after converting virtual local area network identification number with reference to table provided with previously registered correspondence between virtual local area network identification number in regional network and virtual local area network identification number in wide area network.

2. A virtual local area network connecting equipment, according to claim 1, wherein;
said table is further stored with correspondence including regional side port number and wide area side port number, and frame destination port is determined in accordance with said table.

3. A virtual local area network connecting equipment, according to claim 1, wherein:
said virtual local area network identification number in wide area network is provided with larger digit number than said virtual local area network identification number in regional network.

4. A virtual local area network connecting equipment, according to claim 1, wherein:
further includes means for recalculating and rewriting check cord at the end of frame when said virtual local area network identification number is converted.

5. A virtual local area network connecting equipment, comprising:
regional side port connected to a regional network;
wide area side port connected to a wide area network;
means for converting virtual local area network identification number in regional network stored in frame received at regional side port to virtual local area network identification number in wide area network and transmitting said frame from wide area side port;
means for converting virtual local area network identification number in wide area network stored in frame received at wide area side port to virtual local area network identification number in regional network and transmitting said frame from regional side port; and
media access controller which transfers frame between said port and said converter.

6. A virtual local area network connecting equipment, according to claim 5, wherein:
said media access controller is provided with means for storing port number to frame entered from regional side port, transferring frame to converter, and transferring frame to wide area side port in accordance with port number written in the returned frame from converter,
said converter is provided with means for deciding virtual local area network identification number in wide area network and transmitting port number in accordance with receiving port number and virtual local area network identification number in regional network stored in the transferred frame from media access controller, returning to media access controller after rewriting frame from receiving port number and virtual local area network identification number in regional network to decided virtual local area network identification number in wide area network and transmitting port number, deciding virtual local area network identification number in regional network and transmitting port number in accordance with receiving port number and virtual local area network identification number in wide area network stored in the transferred frame from media access controller, and returning to media access controller after rewriting frame from receiving port number and virtual local area network identification number in wide area network to decided virtual local area network identification number in regional network and transmitting port.

7. A virtual local area network connecting equipment, according to claim 5, wherein:
said virtual local area network identification number in wide area network is provided with larger digit number than said virtual local area network identification number in regional network.

8. A virtual local area network connecting equipment, according to claim 5, wherein:
further includes means for recalculating and rewriting check cord at the end of frame when said virtual local area network identification number is converted.

9. A virtual local area network connecting equipment, comprising:
regional side port connected to a regional network;
wide area side port connected to a wide area network;
means for converting virtual local area network identification number in regional network stored in a frame received at regional side port to virtual local area network identification number in wide area network and transmitting said frame from wide area side port;
means for converting virtual local area network identification number in wide area network stored in a frame received at wide area side port to virtual local area network identification number in regional network and transmitting said frame from regional side port; and
media access controller provided between each port of regional side and wide area side and converter which mutually converts virtual local area network identification number in regional network and virtual local area network identification number in wide area network.

10. A virtual local area network connecting equipment, according to claim 9, wherein:
said media access controller connected to regional side port is provided with means for transmitting frame entered from regional side to converter, and transferring frame entered from converter to corresponding regional side port,
said media access controller connected to wide area side port is provided with transmitting frame entered from wide area side to converter, and transferring frame entered from converter to corresponding wide area side port, and
said converter is provided with means for converting virtual local area network identification number in regional network and virtual local area network identification number in wide area network with reference to table provided with previously registered correspondence between virtual local area network identification number in regional network and virtual local area network identification number in wide area network, and transmitting frame to media access controller connected to transmitting port to which frame is transmitted.

11. A virtual local area network connecting equipment, according to claim 9, wherein:
said virtual local area network identification number in wide area network is provided with larger digit number than said virtual local area network identification number in regional network.

12. A virtual local area network connecting equipment, according to claim 9, wherein:
further includes means for recalculating and rewriting check cord at the end of frame when said virtual local area network identification number is converted.

13. A virtual local area network connecting equipment, comprising:
regional side port connected to a regional network;
wide area side port connected to a wide area network;
converter which mutually converts virtual local area network identification number in regional network and a virtual local area network identification number in wide area network; and
media access controller which transfers frame between said port and said converter.

14. A virtual local area network connecting equipment, according to claim 13, wherein:
said converter mutually converts virtual local area network identification number in regional network and virtual local area network identification number in wide area network with reference to table provided with previously registered correspondence between virtual local area network identification number in regional network and virtual local area network identification number in wide area network.

15. A virtual local area network connecting equipment, comprising:
plural regional side port connected to a regional network;
plural wide area side port connected to a wide area network;
converter which mutually converts virtual local area network identification number in regional network and a virtual local area network identification number in wide area network;
media access controller which transfers frame between said plural regional side port and said converter; and
media access controller which transfers frame between said plural wide area side port and said converter.

16. A virtual local area network connecting equipment, according to claim 15, wherein:
said converter mutually converts virtual local area network identification number in regional network and virtual local area network identification number in wide area network with reference to table provided with previously registered correspondence between virtual local area network identification number in regional network and virtual local area network identification number in wide area network.

17. A virtual local area network connecting equipment, comprising:
plural regional side port connected to a regional network;
plural wide area side port connected to a wide area network;
converter which mutually converts virtual local area network identification number in regional network and a virtual local area network identification number in wide area network;
media access controllers each of which is disposed between said each regional side port and said converter and transfers frame between said each regional side port and said converter; and
media access controllers each of which is disposed between said each wide area side port and said converter and transfers frame between said each wide area side port and said converter.

18. A virtual local area network connecting equipment, according to claim 17, wherein:
said converter mutually converts virtual local area network identification number in regional network and virtual local area network identification number in wide area network with reference to table provided with previously registered correspondence between virtual local area network identification number in regional network and virtual local area network identification number in wide area network.
